(19) United States
(12) Patent Application Publication
(10) Pub. No.: US 2018/0113448 A1
(43) Pub. Date: Apr. 26, 2018

(54) VEHICLE ENERGY REDUCTION

(71) Applicant: Ford Global Technologies, LLC, Dearborn, MI (US)

(72) Inventors: Yash Nagda, Pleasanton, CA (US); Nayaz Khalid Ahmed, Canton, MI (US); Ray C. Siciak, Ann Arbor, MI (US)

(73) Assignee: Ford Global Technologies, LLC, Dearborn, MI (US)

(21) Appl. No.: 15/332,300

(22) Filed: Oct. 24, 2016

(51) Int. Cl. G05D 1/00; G05D 1/02

(52) U.S. Cl. CPC G05D 1/0005; H04L 67/12; G05D 1/0027; G05D 1/0295

(57) ABSTRACT

An energy level for each vehicle in a convoy is determined. A following vehicle is assigned as a new lead vehicle when the energy level of a current lead vehicle is below the energy level of the following vehicle.

### BACKGROUND

Vehicles use sensors to collect data while operating, the sensors including radar, LIDAR, vision systems, infrared systems, and ultrasonic transducers. The sensors consume energy from a vehicle battery. Furthermore, computation of data collected by the sensors may generate heat in a vehicle computer, requiring cooling systems that consume more energy. Vehicles travelling along a roadway, each vehicle collecting data using their respective sensors and computers, thus consume energy and generate heat.

### BRIEF DESCRIPTION OF THE DRAWINGS

FIG. 1 is a block diagram of an example system for operating a vehicle in a convoy.

FIG. 2 is a view of an example convoy.

FIG. 3 is a view of an example vehicle joining the convoy of FIG. 2.

FIG. 4 is a view of the example vehicle leaving the convoy and joining a second convoy.

FIG. 5 is a view of the second convoy changing a lead vehicle.

FIG. 6 is an example process for operating the vehicle in the convoy.

### DETAILED DESCRIPTION

In a convoy, a lead vehicle can collect and transmit data to other vehicles. The other vehicles actuate subsystems based on the data collected by the lead vehicle. The other vehicles deactivate one or more sensors when in the convoy and reduce computations in a computing device, reducing the heat generated by the computing device and the energy needed to cool the computing device. For example, computing 3-dimensional (3D) LIDAR data can be power-intensive, and pausing the process of developing, updating, comparing, and transmitting a 3D LIDAR map can provide a significant reduction in operating power of the computing device. Further, certain sensors can be shut down, e.g., LIDAR sensors, that can generate heat and/or be significant energy consumers. Thus, because only the lead vehicle expends the energy to actuate some or all sensors to collect and compute the data, the convoy allows vehicles to reduce the amount of energy consumed during operation. When an energy level of a current lead vehicle drops below the energy level of a following vehicle, that following vehicle is assigned to be the new lead vehicle, and one or more vehicle subsystems in the vehicles are actuated to move the new lead vehicle to the front of the convoy. The convoy thus reduces energy consumption for the vehicles in the convoy and ensures that the lead vehicle has sufficient energy to collect, compute, and transmit data to the other vehicles in the convoy.

As used herein, the term “convoy” refers to a series of vehicles that receive instructions from a lead vehicle to operate vehicle subsystems along a convoy route.

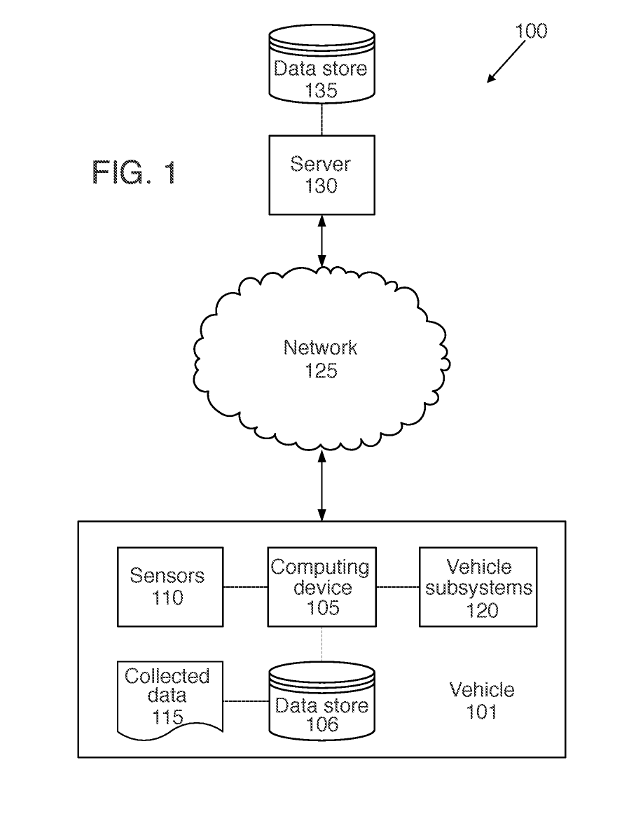

FIG. 1 illustrates a system 100 for operating a vehicle 101 in a convoy. A computing device 105 in the vehicle 101 is programmed to receive collected data 115 from one or more sensors 110. For example, vehicle 101 data 115 may include a location of the vehicle 101, a location of a target, etc. Location data may be in a known form, e.g., geo-coordinates such as latitude and longitude coordinates obtained via a navigation system, as is known, that uses the Global Positioning System (GPS). Further examples of data 115 can include measurements of vehicle 101 systems and components, e.g., a vehicle 101 velocity, a vehicle 101 trajectory, etc.

The computing device 105 is generally programmed for communications on a vehicle 101 network or communications bus, as is known. Via the network, bus, and/or other wired or wireless mechanisms (e.g., a wired or wireless local area network in the vehicle 101), the computing device 105 may transmit messages to various devices in a vehicle 101 and/or receive messages from the various devices, e.g., controllers, actuators, sensors, etc., including sensors 110. Alternatively or additionally, in cases where the computing device 105 actually comprises multiple devices, the vehicle network or bus may be used for communications between devices represented as the computing device 105 in this disclosure. In addition, the computing device 105 may be programmed for communicating with the network 125, which, as described below, may include various wired and/or wireless networking technologies, e.g., cellular, Bluetooth, wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a location of a target, projecting a path of a parking maneuver, evaluating a location of a roadway lane, etc. The sensors 110 could also include short range radar, long range radar, LIDAR, and/or ultrasonic transducers.

The sensors 110 may consume different amounts of power depending on the type of sensor 110. For example, LIDAR sensors 110 may consume more power than, e.g., ultrasonic sensors 110. While in the convoy, the computing device 105 can deactivate one or more of the sensors 110 to reduce overall power consumption of the vehicle 101.

Collected data 115 may include a variety of data collected in a vehicle 101. Examples of collected data 115 are provided above, and moreover, data 115 are generally collected using one or more sensors 110, and may additionally include data calculated therefrom in the computing device 105, and/or at the server 130. In general, collected data 115 may include any data that may be gathered by the sensors 110 and/or computed from such data.

The vehicle 101 may include a plurality of subsystems 120. Each subsystem 120 includes one or more vehicle 101 components that together operate to perform a vehicle 101 function. For example, the subsystems 120 can include, e.g., a propulsion (including, e.g., an internal combustion engine and/or an electric motor, etc.), a transmission, a steering subsystem, a brake subsystem, a park assist subsystem, an adaptive cruise control subsystem, etc. The computing device 105 can perform calculations on the data 115 to actuate the subsystems 120. For example, the computing device 105 can use LIDAR data 115 to develop, update, compare, and transmit a 3D LIDAR map. The calculations increase heat generated by the computing device 105. As a result, the computing device 105 can actuate a cooling subsystem 120 to cool the computing device 105. The cooling subsystem 120 may include devices that transfer heat away from the computing device 105, e.g., fans, pumps, fins, heat sinks, etc. The cooling subsystem 120 can consume more energy than other subsystems 120, and reducing the amount of heat generated by the computing device 105 can reduce the amount of energy spent on the cooling subsystem 120, reducing the overall energy consumption of the vehicle 101.

The computing device 105 may actuate the subsystems 120 to control the vehicle 101 components, e.g., to stop the vehicle 101, to avoid targets, etc. The computing device 105 may be programmed to operate some or all of the subsystems 120 with limited or no input from a human operator, i.e., the computing device 105 may be programmed to operate the subsystems 120. When the computing device 105 operates the subsystems 120, the computing device 105 can ignore input from the human operator with respect to subsystems 120 selected for control by the computing device 105, which provides instructions, e.g., via a vehicle 101 communications bus and/or to electronic control units (ECUs) as are known, to actuate vehicle 101 components, e.g., to apply brakes, change a steering wheel angle, etc. For example, if the human operator attempts to turn a steering wheel during steering operation, the computing device 105 may ignore the movement of the steering wheel and steer the vehicle 101 according to its programming.

When the computing device 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computing device 105.

The system 100 may further include a network 125 connected to a server 130 and a data store 135. The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, vehicle-to-vehicle (V2V) such as Dedicated Short Range Communications (DSRC), etc.), local area networks (LAN) and/or wide area networks (WAN), including the Internet, providing data communication services.

As described below, a convoy can allow vehicles 101 to operate respective subsystems based on data 115 collected by one of the vehicles 101 in the convoy, i.e., the lead vehicle 101. The lead vehicle 101 can collect data 115 with sensors 110 and provide instructions and/or data 115 to the following vehicles 101 in the convoy. Thus, only the lead vehicle 101 expends energy to operate the sensors 110 and compute the data 115 to generate the instructions, and the following vehicles 101 reduce energy consumption by deactivating the respective sensors 110 while in the convoy.

The vehicle 101 can operate in a low power mode. As used herein, the “low power mode” refers to the computing device 105 reducing the processing performed by the computing device 105. Alternatively or additionally, the computing device 105 can deactivate one or more sensors 110 in the low power mode. By reducing the processing performed by the computing device 105, the computing device 105 generates less heat and requires less cooling from the cooling subsystem 120. Alternatively or additionally, as just mentioned, energy can be saved by shutting down certain sensors, e.g., LIDAR sensors. Furthermore, sensors such as ultrasonic sensors 110 for detecting distance to other vehicles in front of the vehicle 101 can remain activated to provide data 115 while the vehicle 101 is in the convoy. Computations performed on data 115 collected by the ultrasonic sensors 110 may be simpler than computations from data 115 collected by the LIDAR sensors 110. Thus, the computing device 105 may require less energy to perform computations based on data 115 from the ultrasonic sensors 110 and these computations can continue in the low power mode. The ultrasonic sensors 110, in addition to a selection of other sensors 110, e.g., rain sensors, temperature sensors, wheel speed sensors, etc., can continue to operate to allow the vehicle 101 to operate in the convoy. As described below, the computing device 105 is programmed to enter the low-power mode, i.e., reduce its own and/or sensor 110 power consumption, upon joining the convoy as a following vehicle 101 and to exit the low-power mode upon becoming a lead vehicle 101 of the convoy or leaving the convoy.

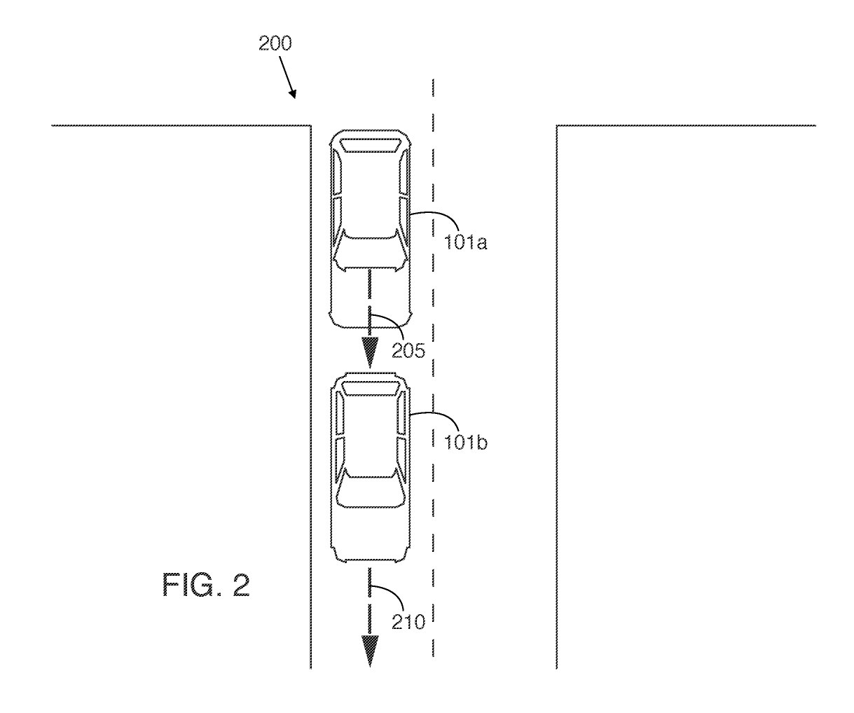

FIG. 2 illustrates an example convoy 200. The convoy 200 of FIG. 2 includes a host vehicle 101a and a convoy vehicle 101b. The host vehicle 101a has a host route 205, and the convoy 200 has a convoy route 210. The host route 205 is a predetermined route typically stored in the data store 106 and used by a navigation subsystem 120 that the host vehicle 101a follows to a destination.

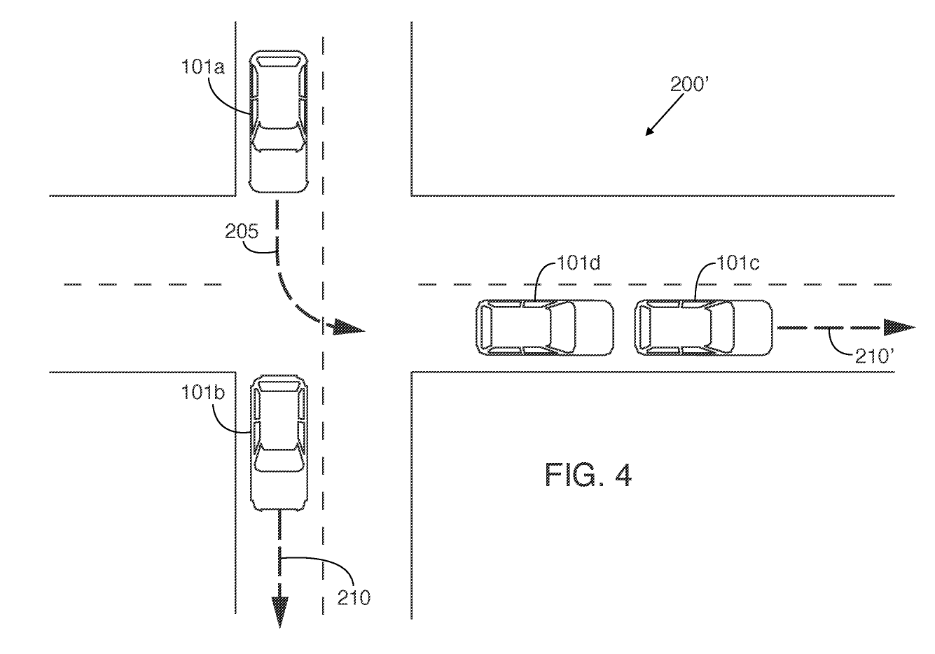

The convoy route 210 is defined by the route of the lead vehicle 101, which is the vehicle 101b in the example of FIG. 2. Upon joining the convoy 200, the host vehicle 101a in the low power mode and the computing device 105a receives instructions from the computing device 105b of the lead vehicle 101b. As described above, in the low power mode, the computing device 105a typically reduces processing performed by the computing device 105a, reducing energy consumed and heat generated by the computing device 105a. Alternatively or additionally, the computing device 105a can deactivate one or more sensors 110a in the low power mode, further reducing energy consumption by saving energy that would power the sensors 110a. When the lead vehicle 101 changes, as described below, the convoy route 210 subsequently changes if the route of the new lead vehicle 101 differs from the route of the previous lead vehicle 101. As long as the route of the vehicle 101b aligns with the host route 205, the host vehicle 101a will remain in the convoy 200. As used herein, the host route 205 “aligns” with the convoy route 210 when the host route 205 and the convoy route 210 overlap, i.e., specify a same roadway and/or portion thereof, and specify movement in a same direction. For example, as shown in FIG. 2, the host route 205 directs the host vehicle 101a down the same roadway lane as the convoy route 210. Thus, at least a portion of the host route 205 aligns with the convoy route 210. When a portion of the host route 205 no longer directs the host vehicle 101a in the same direction as the convoy route 210, the host route 205 “diverges” from the convoy route 210. When the host route 205 diverges from the convoy route 210, the host vehicle 101a leaves the convoy 200, as shown in FIG. 4 below. A new lead vehicle 101 can then be selected, e.g., according to an amount of available energy as described herein.

The lead vehicle 101 is typically the vehicle 101 in the convoy 200 with the highest energy level. As used herein, the “energy level” of a vehicle 101 is defined as the distance that the vehicle 101 can travel on the current energy stores of the vehicle 101, e.g., a state of charge of a vehicle 101 battery, a fuel level of a vehicle 101 fuel tank, and/or a distance-to-empty value, etc. Each computing device 105 in the vehicles 101 in the convoy 200 tracks the energy level of its respective vehicle 101 and shares the energy level with the other computing devices 105.

When the energy level of the lead vehicle 101 drops below the energy level of one of the following vehicles 101, the computing devices 105 of the convoy vehicles 101 assign the vehicle 101 with the currently highest energy level as the new lead vehicle 101. Alternatively, the computing devices 105 can assign a new lead vehicle 101 when the energy level of the current lead vehicle 101 drops below a predetermined threshold. That is, changing the lead vehicle 101 can cost a predetermined amount of energy, e.g., 2% of the current energy level. The computing devices 105 can be programmed to change the lead vehicle 101 when the energy level of the current lead vehicle 101 drops below the energy level of the next-highest vehicle 101 by the predetermined amount of energy. The energy level of the next-highest following vehicle 101 less the predetermined amount of energy thus in this example defines the predetermined threshold. The computing devices 105 can determine to change the lead vehicle 101 when the lead vehicle 101 has an energy level lower than the highest energy level of the convoy vehicles 101 by more than the predetermined amount of energy. Thus, the lead vehicle 101 may have a lower energy level than the vehicle 101 with the highest energy level if the difference between their respective energy levels is less than the predetermined amount of energy. In the example of FIG. 2, the energy level of the vehicle 101b is higher than the energy level of the host vehicle 101a, so the computing devices 105a, 105b determine that the vehicle 101b should remain the lead vehicle 101. Thus, the host vehicle 101a remains in the low power mode.

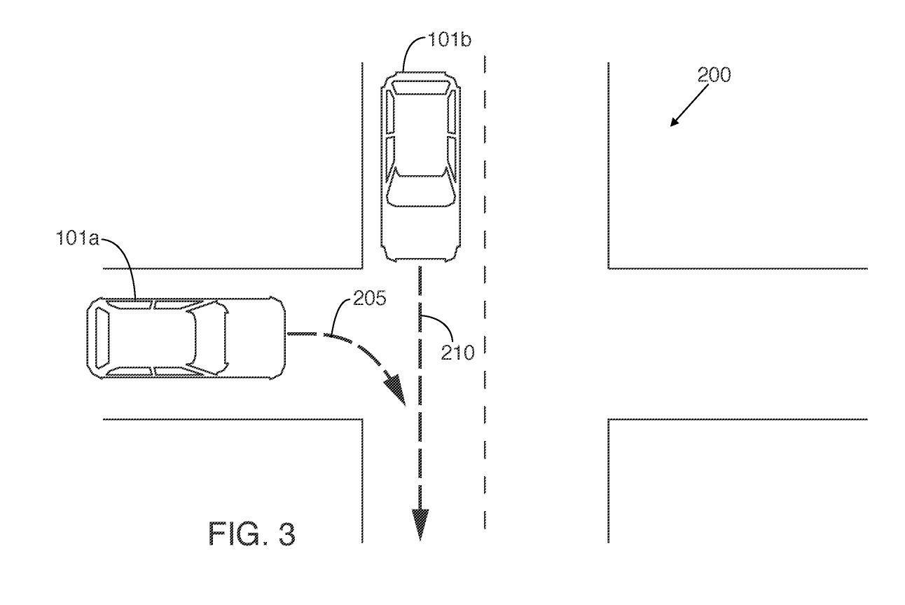

FIG. 3 illustrates the host vehicle 101a joining the convoy 200. The computing device 105a of the host vehicle 101a determines that the host route 205 will align with the convoy route 210; therefore, the computing device 105a determines to join the convoy 200. The computing device 105a sends a notification with the energy level of the host vehicle 101a to the computing device 105b of the vehicle 101b, and the computing device 105b sends a notification with the energy level of the lead vehicle 101b to the computing device 105a. In the example of FIG. 3, the computing devices 105a, 105b determine that the energy level of the vehicle 101b is higher than the energy level of the host vehicle 101a, so the computing devices 105a, 105b determine that the vehicle 101b should remain the lead vehicle 101 of the convoy 200.

The computing device 105b of the lead vehicle 101b sends data 115 and/or instructions to the computing device 105a of the host vehicle 101a in the convoy 200. The computing device 105a follows the instructions to operate the host vehicle subsystems 120a to move the host vehicle 101a along the convoy route 210. The host vehicle 101a enters the low power mode, i.e., the computing device 105a reduces computations performed by the computing device 105a while in the convoy 200. The computing device 105a can, alternatively or additionally, deactivate one or more sensors 110a upon entering the low power mode. Thus, the computing device 105a requires less power (e.g., to cool the computing device 105a, to power the deactivated sensors 110a, etc.), and the host vehicle 101a can move along the convoy route 210 while reducing energy consumption. The computing devices 105a, 105b can compare energy levels of the host vehicle 101a, 101b, as described below.

As shown in FIG. 3, the host route 205 will align with the convoy route 210, so the computing device 105a of the host vehicle 101a is programmed to move the host vehicle 101a to join the convoy 200. That is, the computing device 105a actuates one or more vehicle subsystems 120a to move the host vehicle 101a behind the vehicle 101b in the convoy 200. The host vehicle 101a enters the low power mode, reducing the computations performed by the computing device 105a. Alternatively or additionally, the computing device 105a can deactivate one or more sensors 110a in the low power mode. The computing device 105a communicates with the computing device 105b of the vehicle 101b to receive instructions and data 115 from the vehicle 101b.

FIG. 4 illustrates the host vehicle 101a leaving the convoy 200 and joining another convoy 200′. In the example of FIG. 4, the host vehicle 101a starts in a first convoy 200, led by a first convoy vehicle 101b and following a first convoy route 210. As the host route 205 diverges from the first convoy route 210, the host vehicle 101a exits the low power mode and the computing device 105a stops following instructions from the first convoy vehicle 101b. The computing device 105a searches for a new convoy 200 that aligns with the host route 205. FIG. 4 illustrates a second convoy 200′, led by a second convoy vehicle 101c that moves along a second convoy route 210′. A third convoy vehicle 101d is also in the second convoy 200′. The second convoy vehicle 101c is the lead vehicle 101 in the second convoy 200′, and a respective computing device 105c sends data 115 to the computing device 105a of the host vehicle 101a and a computing device 105d of the third convoy vehicle 101d.

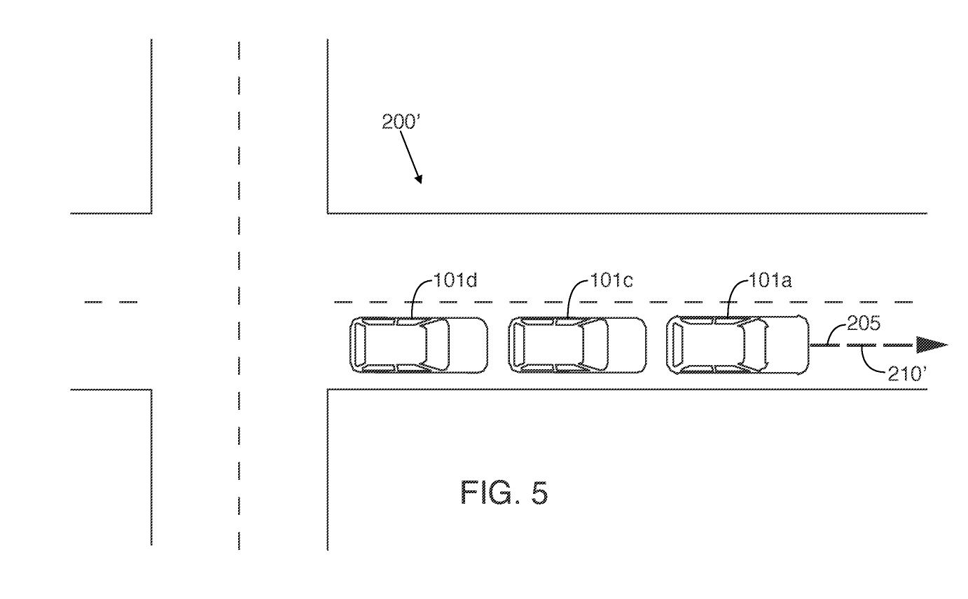

FIG. 5 illustrates the convoy 200 changing the lead vehicle 101. As described above, the lead vehicle 101 provides instructions to the other vehicles 101 in the convoy 200 to reduce the energy consumed by the other vehicles 101. That is, rather than each vehicle 101 consuming energy to collect data 115 with sensors 110, the lead vehicle 101 collects the data 115 and uses the data 115 to determine instructions that the computing devices 105 of the following vehicles 101, each following vehicle 101 operating in the low power mode, follow to move along the convoy route 210.

In the example of FIG. 4, the convoy 200′ starts with the vehicle 101c as the lead vehicle 101. When the host vehicle 101a joins the convoy 200′, the computing devices 105a, 105c, 105d of the host vehicle 101a and the convoy vehicles 101c, 101d transmit their respective energy levels to each other over the network 125, e.g., V2V. The computing devices 105a, 105c, 105d determine that the host vehicle 101a has the highest energy level and thus that the host vehicle 101a should become the lead vehicle 101. Alternatively, the computing devices 105a, 105c, 105d can send the energy levels of their respective vehicles 101a, 101c, 101d to the server 130, and the server 130 can determine which one of the vehicles 101a, 101c, 101d has the highest energy level and can assign that vehicle 101 to be the new lead vehicle 101.

The host vehicle 101a exits the low power mode and the computing device 105a actuates one or more vehicle subsystems 120a to move the host vehicle 101a to the front of the vehicle 101c, as shown in FIG. 5, to a lead vehicle 101 position. The host vehicle 101a begins collecting data 115 and performing computations to process the data 115 with the computing device 105a. The host vehicle 101a can further reactivate one or more sensors 110a that were deactivated when the host vehicle 101a entered the low power mode. For example, the computing device 105a can actuate a propulsion to accelerate the host vehicle 101a in front of the convoy vehicles 101c, 101d. Alternatively, the computing devices 105c, 105d can actuate brakes in the convoy vehicles 101c, 101d to slow the convoy vehicles 101c, 101d until the host vehicle 101a is in front of the convoy 200′. The vehicle 101c then enters the low power mode, reducing processing performed by the computing device 105c to reduce energy consumption, and the computing device 105c receives data 115 and instructions from the computing device 105a of the host vehicle 101a. The vehicle 101c can further deactivate one or more sensors 110c upon entering the low power mode.

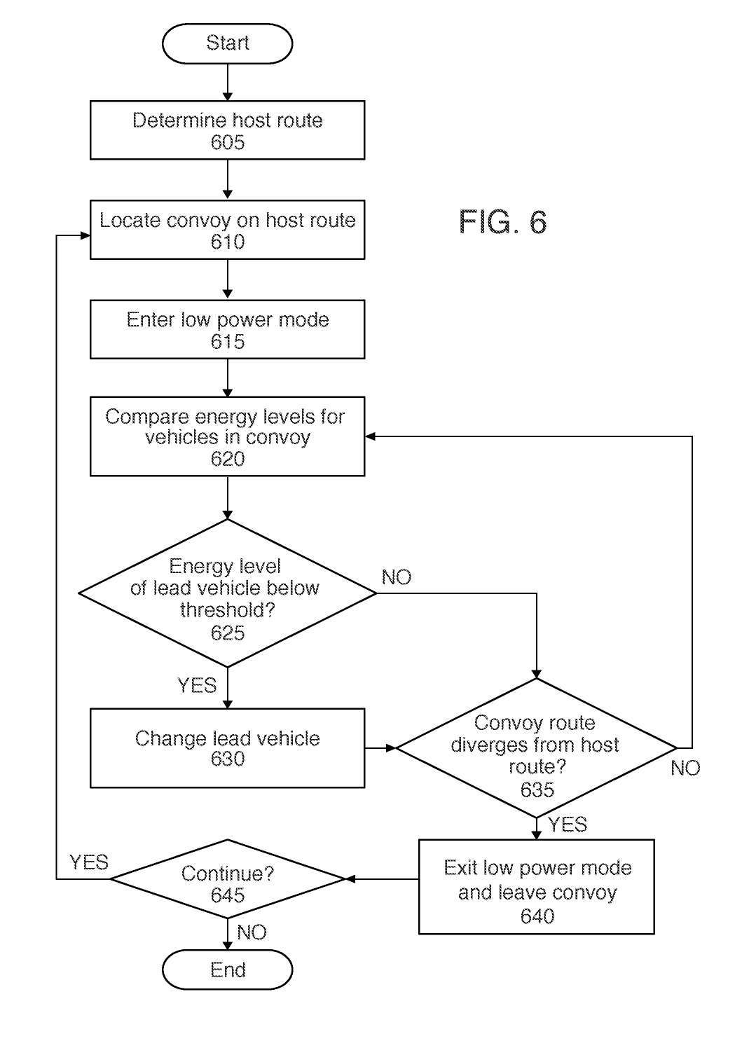

FIG. 6 illustrates an example process 600 for joining a convoy 200. The process 600 can be performed by the computing devices 105 in the vehicles 101 in the convoy 200, e.g., the host vehicle 101a. Alternatively, one or more steps of the process 600 can be performed by the server 130 in communication with vehicle 101 computing devices 105. The example of FIG. 6 illustrates the process 600 performed by a computing device 105 of a host vehicle 101 seeking a convoy 200.

The process 600 begins in a block 605 in which a host vehicle 101 computing device 105 determines a host route 205 for the host vehicle 101. The computing device 105 moves the host vehicle 101 along the host route 205, and can actuate vehicle subsystems 120 to follow the host route 205 with no human operator input. The computing device 105 can determine the route 205 using known route-determination techniques, e.g., where an origin or current location, as well as a destination, are input.

Next, in a block 610, the computing device 105 identifies a convoy 200 along the host route 205. By joining the convoy 200, the host vehicle 101 can reduce energy consumption by accepting instructions from the lead vehicle in the convoy 200 and operating the vehicle subsystems 120 according to the instructions. The computing device 105 can receive convoy routes 210 from one or more lead vehicles 101 over the network 125 (e.g., V2V) and determine whether the host route 205 aligns with one or more of the convoy routes 210. Alternatively, lead vehicles 101 of one or more convoys 200 in a geographic area, e.g., a predetermined radius from a host vehicle 101, can send the convoy routes 210 to the server 130, and the computing device 105 can send a request to the server 130 to identify convoys 200 and convoy routes 210 within the geographic area. The computing device 105 can compare the convoy routes 210 to the host route 205 and identify convoy routes 210 that align with the host route 205. When the computing device 105 determines a convoy route 210 that aligns with at least a portion of the host route 205, the computing device 105 can locate the convoy 200 associated with that convoy route 210.

Next, in a block 615, the vehicle 101 enters the low power mode. As described above, the computing device 105 reduces processing performed by the computing device 105. As a result, the computing device 105 generates less heat, and the cooling subsystem 120 consumes less power to cool the computing device 105. The computing device 105 can further deactivate one or more sensors 110 to reduce power consumption and heat generation. While the vehicle 101 is a following vehicle 101, the vehicle 101 remains in the low power mode and the computing device 105 receives instructions from the lead vehicle 101 of the convoy 200.

Next, in a block 620, the computing device 105 of the host vehicle 101 compares energy levels of the host vehicle 101 and the convoy vehicles 101 in the convoy 200. As described above, the computing devices 105 of the vehicles 101 in the convoy 200 share their respective energy levels over the network 125, e.g., V2V communications. Each computing device 105 can be programmed to compare the energy levels of the vehicles 101 and determine the vehicle 101 with the highest energy level. Alternatively, each computing device 105 can send the energy level of its respective vehicle 101 to the server 130, and the server 130 can be programmed to compare the energy levels. The energy levels may be determined according to one or more of, e.g., a state of charge of a vehicle 101 battery, a fuel volume in a vehicle 101 fuel tank, a distance-to-empty value, etc. In particular, the computing device 105 of the host vehicle 101 compares the energy level of the lead vehicle 101 to the energy levels of the following vehicles 101 in the convoy 200.

Next, in a block 625, the computing device 105 of the host vehicle 101 determines whether the energy level of the lead vehicle 101 is below a predetermined energy level threshold. Alternatively, one of the computing devices 105 of one of the other vehicle 101 in the convoy 200 and/or the server 130 can determine whether the energy level of the lead vehicle 101 is below the predetermined energy level threshold. Typically, the lead vehicle 101 is the vehicle 101 in the convoy 200 with the highest energy level. Thus, the predetermined energy level threshold can be the energy level of the next-highest vehicle 101. Alternatively, because changing lead vehicles 101 requires energy, the predetermined energy level threshold may be the energy level of the next-highest vehicle 101 less a predetermined value, e.g., 2% of the energy level of the lead vehicle 101. If the energy level of the lead vehicle 101 is below the energy level threshold, the process 600 continues in a block 630. Otherwise, the process 600 continues in a block 635.

In the block 630, the computing devices 105 of the host vehicle 101 assigns the following vehicle 101 with the highest energy level as the new lead vehicle 101 and communicates the assignment to the computing devices 105 of the other vehicles 101 over, e.g., V2V. Alternatively, one of the other computing devices 105 of the other vehicles 101 and/or the server 130 can assign the following vehicle 101 with the highest energy level as the new lead vehicle 101. Upon receiving the assignment, the computing devices 105 of the convoy vehicles 101 adjust vehicle subsystems 120 to change the position of the current lead vehicle 101 with the new lead vehicle 101. For example, the new lead vehicle 101 may actuate a propulsion to accelerate in front of the other vehicles 101, the convoy vehicles 101 may actuate their respective brakes to allow the new lead vehicle 101 to pass the other vehicles 101, etc. The new lead vehicle 101 exits the low power mode, increasing processing performed by its computing device 105. The new lead vehicle 101 can reactivate one or more sensors 110 that were previously deactivated when the vehicle 101 was in the low power mode. The previous lead vehicle 101 (now a following vehicle 101) enters the low power mode, reducing processing performed by its computing device 105. The previous lead vehicle 101 can deactivate one or more sensors 110 to further reduce power consumption.

In the block 635, the computing device 105 of the host vehicle 101 determines whether the convoy route 210 diverges from the host route 205. The computing device 105 compares the convoy route 210 to the host route 205 and determines the point where the host route 205 diverges from the convoy route 210, i.e., the convoy 200 moves in a direction away from the host route 205. If the convoy route 210 diverges from the host route 205, the process 600 continues in a block 640. Otherwise, the process 600 returns to the block 620.

In the block 640, the vehicle 101 exits the low power mode and the computing device 105 actuates the vehicle subsystems 120 to move the host vehicle 101 from the convoy 200. As described above, the computing device 105 begins to compute the data 115 received from the sensors 110 that was previously collected by the lead vehicle 101 of the convoy 200. The computing device 105 can reactivate the sensors 110 that may have been deactivated when the vehicle 101 was in the low power mode. The computing device 105 then actuates the vehicle subsystems 120 based on the data 115 to move along the host route 205 away from the convoy 200.

Next, in a block 645, the computing device 105 determines whether to continue the process 600. For example, the computing device 105 can determine the host vehicle 101 has arrived at the final destination of the host route 205, so the computing device 105 determines not to continue the process 600, and the process 600 ends. Alternatively, the computing device 105 can determine that there are one or more convoys 200 along the host route 205, so the computing device 105 determines to continue the process 600 and return to the block 610 to locate the next convoy 200.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, Python, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computing device 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 600, one or more of the steps could be omitted, or the steps could be executed in a different order than shown in FIG. 6. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising a computer including a processor and a memory, the memory storing instructions executable by the computer to:
determine an energy level for each vehicle in a convoy; and
assign a following vehicle as a new lead vehicle when the energy level of a current lead vehicle is below the energy level of the following vehicle.

2. The system of claim 1, wherein the instructions further include instructions to actuate one or more subsystems to move ahead of one or more other vehicles in the convoy upon being assigned the new lead vehicle.

3. The system of claim 1, wherein the instructions further include instructions to leave the convoy and join a second convoy.

4. The system of claim 1, wherein the instructions further include instructions to reactivate one or more sensors and to transmit data collected by the one or more sensors to the following vehicles in the convoy upon being assigned the new lead vehicle.

5. The system of claim 1, wherein the instructions further include instructions to send a notification with the energy level of each of the vehicles to a computer in each of the vehicles when a new vehicle joins the convoy.

6. The system of claim 1, wherein the instructions further include instructions to send a message to one or more following vehicles to actuate one or more subsystems in the following vehicles.

7. The system of claim 1, wherein the instructions further include instructions to determine a route for a host vehicle, identify a first convoy having a convoy route that aligns with at least a portion of the route, and actuate one or more host vehicle subsystems to join the first convoy.

8. The system of claim 1, wherein the instructions further include instructions to deactivate one or more sensors upon joining the convoy as a following vehicle and to reactivate the one or more sensors upon leaving the convoy.

9. The system of claim 1, wherein the instructions further include instructions to reduce processing performed by the processor upon joining the convoy.

10. The system of claim 9, wherein the instructions further include instructions to deactivate one or more sensors upon joining the convoy.

11. A method, comprising:
determining an energy level for each vehicle in a convoy; and
assigning a following vehicle as a new lead vehicle when the energy level of a current lead vehicle is below the energy level of the following vehicle.

12. The method of claim 11, further comprising actuating one or more subsystems to move ahead of one or more other vehicles in the convoy upon being assigned the new lead vehicle.

13. The method of claim 11, further comprising leaving the convoy and joining a second convoy.

14. The method of claim 11, further comprising reactivating one or more sensors and transmitting data collected by the one or more sensors to the following vehicles in the convoy upon being assigned the new lead vehicle.

15. The method of claim 11, further comprising sending a notification with the energy level of each of the vehicles to a computer in each of the vehicles when a new vehicle joins the convoy.

16. The method of claim 11, further comprising sending a message to one or more following vehicles to actuate one or more subsystems in the following vehicles.

17. The method of claim 11, further comprising determining a route for a host vehicle, identifying a first convoy having a convoy route that aligns with at least a portion of the route, and actuating one or more host vehicle subsystems to join the first convoy.

18. The method of claim 11, further comprising deactivating one or more sensors upon joining the convoy as a following vehicle and reactivating the one or more sensors upon leaving the convoy.

19. The method of claim 11, further comprising reducing processing performed by a processor of a vehicle computer upon joining the convoy.

20. The method of claim 19, further comprising deactivating one or more sensors and upon joining the convoy.
